(19) United States
(12) Patent Application Publication
(10) Pub. No.: US 2005/0059405 A1
(43) Pub. Date: Mar. 17, 2005

(54) Simulation driven wireless LAN planning

(75) Inventors: Allan Thomson, Pleasanton, CA (US); Sudhir Srinivas, Fremont, CA (US)

Correspondence Address: WILSON SONSINI GOODRICH & ROSATI, 650 PAGE MILL ROAD, PALO ALTO, CA, 943041050, US

(73) Assignee: Trapeze Networks, Inc., Pleasanton, CA (US)

(21) Appl. No.: 10/667,027

(22) Filed: Sep. 17, 2003

(51) Int. Cl. H04Q 7/20

(52) U.S. Cl. 455/446; 455/422.1

(57) ABSTRACT

Methods and apparatuses of planning a wireless local area network are disclosed. Various embodiments receive data such as floor plan data, coverage data, and/or capacity data about a site for the WLAN. Based on such data, features of the WLAN access points can be determined. Examples are the quantity, placement, and/or configuration of the access points.

### BACKGROUND

Pre-deployment planning of a wireless local area network (WLAN) typically requires a manual site survey. The manual site survey requires an expensive and time-consuming evaluation of the WLAN site, including taking RF signal strength measurements and path loss level measurements, and assessing appropriate areas for placing access points. Moreover, the site survey is coverage oriented, and not capacity oriented. Even if access points are deployed in accordance with the results of the survey, the WLAN may be able to satisfy a light throughput throughout the entire WLAN site, and yet be easily overwhelmed by capacity demands. Therefore, it would be desirable to reduce the labor associated with pre-deployment planning, such as the labor associated with the manual site survey.

The predeployment assumptions which drove the deployment of the access points of a WLAN can become irrelevant quickly, in the dynamic environment of a WLAN. Assumptions about the capacity, location, and applications of the WLAN users may change dramatically from the time of a prior manual survey or a prior simulation. Therefore, the ability to rapidly adjust the configurations of the access points permits the WLAN to adjust to the changing requirements of the users. Rapidly changing user requirements requires maintaining an accurate picture of the currently implemented WLAN. In anything but the simplest wireless deployments, maintaining accurate records of the current configurations of multiple access points, with different channel assignments, power levels, locations, etc. is nontrivial. When not just one access point, but multiple access points, experience changing configurations, not just once, but multiple times, any central record of the access point configurations may be nonexistent, or worse, inaccurate. In the case of a nonexistent configuration record, the configuration of each and every access point may need to be verified. In the case of an inaccurate configuration record, modifying the configurations of the access points may actually worsen, instead of enhance, the performance of the WLAN. Therefore, it can be desirable to reduce the overhead associated with maintaining the configurations of WLAN access points.

### BRIEF SUMMARY OF THE INVENTION

Methods and apparatuses of planning a wireless local area network are disclosed. Various embodiments receive data such as floor plan data, coverage data, and/or capacity data about a site for the WLAN. Based on such data, features of the WLAN access points can be determined. Examples are the quantity, placement, and/or configuration of the access points.

### BRIEF DESCRIPTION OF FIGURES

FIG. 1 shows an example deployment of a WLAN.

FIG. 2 shows an example method of planning a WLAN.

FIG. 3 illustrates a computer programmed from program media.

FIG. 4 illustrates a computer programmed from a network.

### DETAILED DESCRIPTION

The manual site survey can be replaced with WLAN simulation that considers floor plans and capacity. Various physical factors are considered in the WLAN simulation, such as: architectural factors (e.g., building size, building topology, obstacles, and office sizes), attenuation factors for different objects (e.g., walls, windows, cubicles, doors, elevators, other fixed objects) and/or types of material (e.g., free space, metal, concrete, plaster, cloth partition), and interference sources (e.g., microwave ovens, cordless phones, Bluetooth devices). Other coverage factors include transmitter power, receiver sensitivity at the target communications rate, and target operational link margin.

The WLAN simulation accounts for WLAN bandwidth capacity shared by all users, and not just coverage. Because air is a shared medium and not a switched medium, focusing exclusively on coverage can yield nonideal results, such as for anything but the simplest deployments such as a single access point.

The capacity calculation can consider application bandwidth, associating areas with applications and user groups. Simple web browsing and e-mail applications tend to cause less radio activity than enterprise resource planning or customer relationship management applications. A particular area of a WLAN site can contain multiple coverage areas if several groups of users in the area require differing bandwidth from the network. For example, engineering applications of an engineering workgroup may be more bandwidth-intensive than office applications used by sales and marketing. Also considered are bandwidth per user, number of users, activity rate per user, overhead efficiency (e.g., MAC inefficiency and error correction overhead), the wireless standard (802.11a/b/g), country of operation, and baseline association rate for the wireless standard. Adequate bandwidth and adequate coverage can be assured by computing a sufficient number of access points. Margin can be designed to allow for future growth, new users, and users roaming into area

The placement and final settings of access points are determined. User density and cell size are adjusted by adjusting access point transmit power settings and the distance between access points. Microcells with lower access point settings can be planned closer together, sharing more bandwidth among fewer users per access point. In contrast, increased distance from access points decreases signal strength and lowers capacity. Also potentially adjustable is the minimum association rate, the lowest RF signal strength which can support the lowest data rate below which a user must associate with another access point. This can prevent slow users who take more air time for transmissions and slow the throughput of other users. Adjusting access point transmitted power can increase frequency re-use flexibility and reduce co-channel interference. Channel allocation among the access points is optimized, automatically identifying channel conflicts and assigning channels. Automatic channel assignment to the access-points minimizes co-channel interference and increase throughput, taking advantage of the three non-overlapping channels of 802.11b, and the eight or more non-overlapping channels of 802.11a.

Adding an access point, or adjusting an existing access point's configuration, impacts surrounding access points. Thus, addition of a new access point or modification of access point configuration can result in automatic recalculation of channel assignments and power levels for all access points. Adjusting all access points at the system level, and resimulating the RF topology, confirms sufficient bandwidth. This type of planning can not only model the deployment of a brand new WLAN deployment, but also model the addition of new access points to an already deployed WLAN.

The simulation can generate work orders including installation plans depicting actual physical location and dimensions on a floor plan for access point installation and/or distribution system switch installation.

RF measurements can troubleshoot differences between expected and actual WLAN performance. Verification of the actual WLAN performance which was planned pre-implementation should not wait for user complaints in response to network access outage or slow bandwidth experienced by users. Further, these measurements can fine-tune future deployments of access points or configuration adjustments of existing access points.

Periodic RF measurements can verify and update elements of the configuration planned at predeployment time (e.g., access point placement, wired ports, expected RF signal strength, coverage, channel assignment, transmit power).

The actual RF topology can be superposed onto the original design to speed troubleshooting. Combining this map, which maps all authorized access points onto floor plans, with regular RF sweeps of every access point to listen across every channel, can show a complete view of all access points and stations. Comparison of the map of all authorized access points with the RF sweep map allows detection and location of rogue access points. Comparison of all authorized users with users detected from the RF sweep map also allows detection and location of rogue stations. The rogue access point or station can be triangulated from the access points.

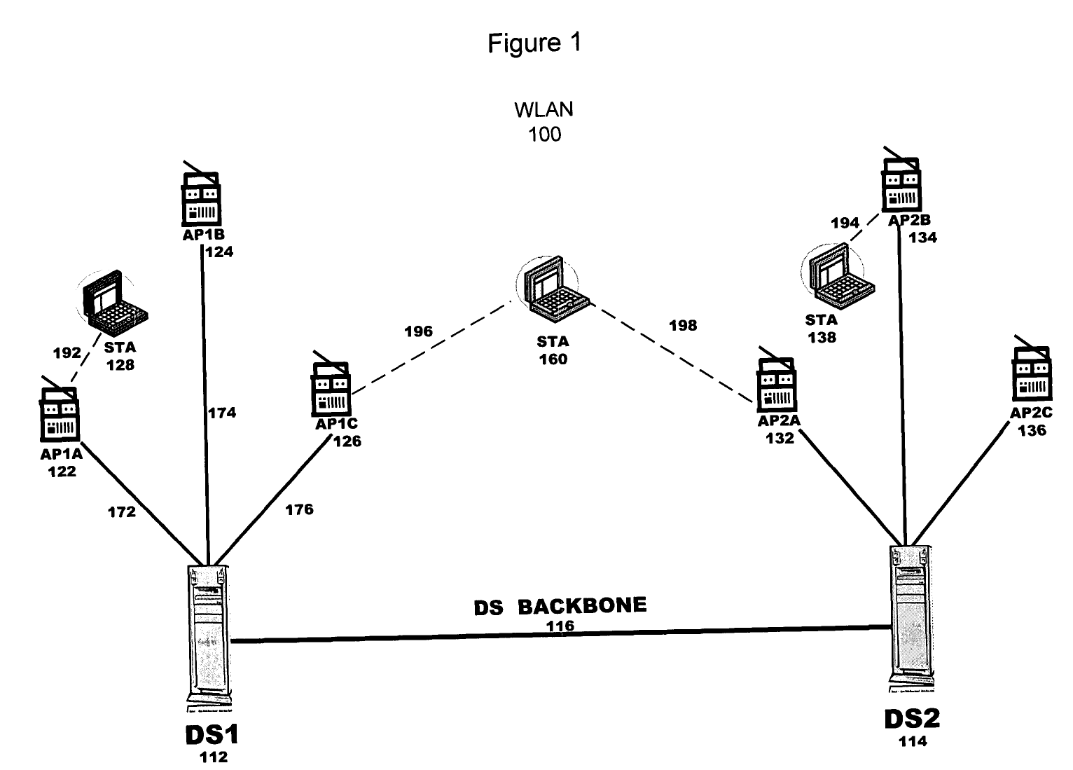

FIG. 1 shows an example deployment of a WLAN 100. The distribution system 110 includes a first distribution system switch DS 1 112, a second distribution system switch DS2 114, and a distribution system backbone 116 connecting the first distribution system switch DS1 112 and the second distribution system switch DS2 114. A first extended service set network ESS 1120 includes the first distribution system switch DS1 112, access point APIA 122, access point APIB 124, access point APIC 126, and station 128. Access point APIA 122, access point APIB 124, and access point AP1C 126 are connected to the first distribution system switch DS 1 112 by wired links 172, 174, and 176, respectively. Station 128 and access point APIA 122 are connected via wireless link 192, and form a first basic service set network BSS1 140. A second extended service set network ESS2 130 includes the second distribution system switch DS2 114, access point AP2A 132, access point AP2B 134, access point AP2C 136, and station 138. Access point AP2A 132, access point AP2B 134, and access point AP2C 136 are connected to the second distribution system switch DS2 114 by wired links 182, 184, and 186, respectively. Station 138 and access point AP2B 134 are connected via wireless link 194, and form a second basic service set network BSS2 150. Station 160 is in process of being handed off between access point APIC 126 of the first extended service set network ESS1 120 and access point AP2A 132 of the second extended service set network ESS2 130, and thereby is associated with two wireless links 196 and 198 to access point APIC 126 and access point AP2A 132, respectively.

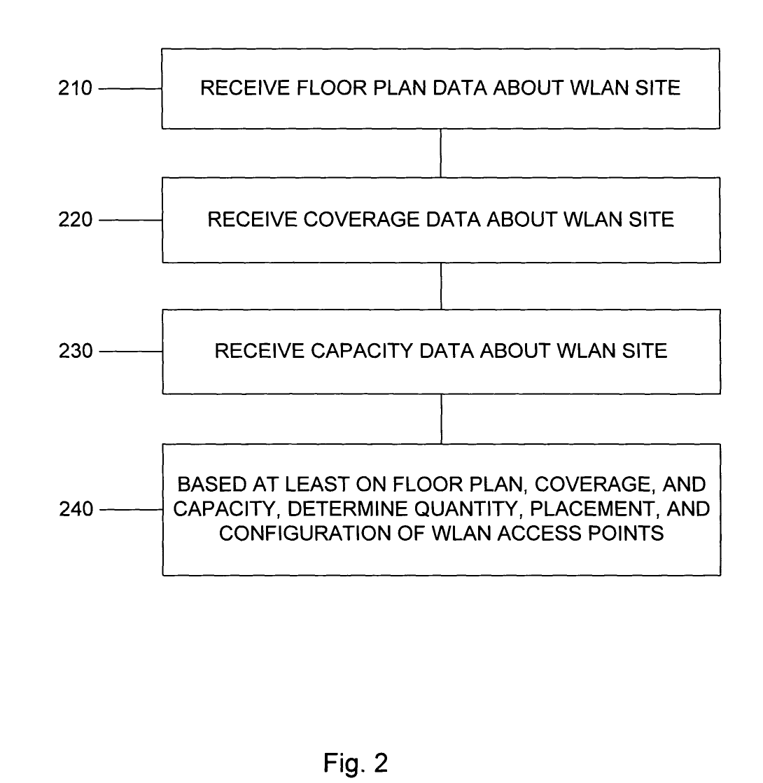

FIG. 2 shows an example of a method for managing a WLAN. In 210, floor plan data about a site for the WLAN are received. The floor plan data has objects which can be associated with radio frequency attenuation factors. For example, walls, windows, doors, and cubicles absorb RF signals. Different materials have different attenuation factors. The attenuation factors can depend also on a technology standard of the WLAN, such as 802.11a or 802.11b. The floor plan data can be imported and/or manually drawn via computer. Examples of file types which can be imported are: AutoCAD drawings (DWG), Drawing Interchange Format (DXF), Graphics Interchange Format (GIF), and/or Joint Photographic Experts Group (JPEG). CAD drawings, such as DWG and DXF, can have advantages such as appropriately scaled, dimensionally accurate, floor plan data; vector graphics based drawings, and/or drawing objects grouped together and/or organized by layers, enabling the display and/or manipulation of similar objects such as walls, doors, and/or windows.

Objects can be graphically placed in the floor plan data and assigned an obstacle type and attenuation factor. Also, an obstacle type and attenuation factor can be assigned to objects in a CAD drawing. These values can be used when calculating coverage for the network. Objects can also be created manually. If a drawing is not entirely accurate, objects can be added and/or deleted to reflect floor plan data changes not included in the drawing. Grouping objects is useful. For example, one attenuation factor can be applied to an area. For expediency, all objects in a layer of a CAD drawing can be converted into objects, all objects in an area of any drawing can be converted into objects, multiple objects in a drawing can be converted into objects, and/or grouped objects in any drawing can be converted into RF obstacles.

In the event an access point is placed on a partial wall or other vertical surface, such as partial walls or other vertical surface can be treated as a full walls with, for example, 100 dB attenuation, to accurately model the predicted coverage. Other models can be applied as well, such as lower or higher attenuation.

In 220, coverage data about the site for the WLAN are received. The coverage data can indicate the coverage areas of the site serviced by the WLAN access points. The coverage data can be indicated by at least the floor plan data. The coverage data can depend on a technology standard of the WLAN. A coverage area can support one or multiple technology standards of the WLAN; also, multiple coverage areas can support one or multiple technology standards of the WLAN. The coverage areas can overlap partly or wholly. Coverage areas can be given more or more properties, such as average desired association rate for typical clients in the coverage area, station throughput (transmit or receive or combined transmit and receive) should not exceed average desired association rate.

In 230, capacity data about the site for the WLAN are received. The capacity data can include one or more throughput rates for stations serviced by the WLAN access points. Examples of throughput rates are 1Mbps for 802.11b and 5Mbps for 802.11a. The capacity data can include one or more average desired association rates for stations serviced by the WLAN access points. The capacity data can include one or more quantities of stations serviced by the WLAN access points. The quantity can characterize, for example, active stations serviced by the WLAN access points and/or a total number of stations serviced by the WLAN access points. The quantity can be expressed as, for example, a number of stations and/or may be a ratio. An example of a ratio is a ratio of active clients compared to total clients. For example, the ratio 5:1 indicates that, statistically, 20 percent of the clients are active at any given time.

Association data can be received in some embodiments. Based at least on the association data, quantity, placement, and configuration of the WLAN access points can be determined. The association data can include allowable channels for the WLAN access points. If certain channels need to be avoided completely in the coverage area, such restrictions can be defined. For example, a multi-tenant building agreement might require an exclusive subset of channels for another tenant. For some particular WLAN access points, the channel allocation process can automatically avoid the channel of those particular access points at least in the immediate area of those particular access points. This can make the listing of restricted channels unnecessary.

The association data can include one or more minimum rates for beacons of the WLAN access points and/or one or more minimum rates for probe responses of the WLAN access points. A minimum transmit rate can be the minimum data rate for beacons and/or probe responses. The minimum transmit rate can facilitate faster roaming between access points. In one scenario, 802.11b devices can send beacons at the higher of, for example, 2 Mbps or a minimum transmit rate. In another scenario, 802.11a devices can send beacons at the higher of, for example, 24 Mbps or a minimum data transmit rate. The minimum transmit rate can depend on the radio type. Some example values for 802.11b devices are 11, 5.5, 2, and 1 Mbps. Some example values for 802.11a radios are 54, 48, 36, 24, 18, 12, 9, and 6 Mbps. Association data can also include the domain, and/or any other coverage area sharing access points with this coverage area.

In 240, based at least on the floor plan data, the coverage data, and the capacity data, the quantity, placement, and configuration of WLAN access points are determined.

The configuration of WLAN access points can include multi-homing for the WLAN access points. The configuration of the WLAN access points can include power levels for the WLAN access points. Power levels, such as transmit power levels, must be high enough to adequately cover an area, but should not be too high in order to help reduce co-channel interference. The configuration can include channel assignments for the WLAN access points.

The placement of the WLAN access points can be manually adjustable via computer. Based at least on such manually adjusted placement of the WLAN, the quantity and/or configuration of the WLAN access points can be determined. Also, based at least on such manually adjusted placement of at least one WLAN access point, the placement of at least one other WLAN access point can be determined. Further, based at least on such manually adjusted placement of at least one WLAN access point, the coverage data and/or the capacity data of the WLAN site can be determined. Manual adjustment by adding/removing/moving access points can help to more adequately cover holes in RF coverage of the WLAN access points.

In some embodiments, at least the quantity and placement of the WLAN access points are displayed.

Also, the quantity and/or the configuration of the WLAN access points can be manually adjustable via computer. Based at least on such manual adjustments, the placement, quantity and/or configuration of the WLAN access points can be determined. Also, based at least on such manual adjustments, the coverage data and/or the capacity data of the WLAN site can be determined. When defining a coverage area, the coverage area should extend to the inside of external walls, or else the external walls can be accounted for when computing how many access points are required for the coverage area. In some embodiments, even if external walls are included in the coverage area, the access point computation can automatically truncate the coverage area to exclude the external walls.

In some embodiments, preexisting access point data can be received. Based at least on the preexisting access point data, the quantity, placement, and/or configuration of the WLAN access points can be determined.

Work order data can be generated, based at least on the quantity, the placement, and the configuration of the WLAN access points, and/or based at least on one or more changes for the floor plan data about the WLAN site, the quantity of WLAN access points, the placement of WLAN access points, and/or the configuration of the WLAN access points. The work order data can include installation instructions for the WLAN access points and/or installation instructions for one or more distribution system switches connecting the WLAN access points.

Some embodiments can receive wiring closet data. The wiring closet data can indicate one or more locations for one or more distribution system switches and/or other networking devices at the site for the WLAN. The distribution system switches connect the WLAN access points. Based at least partly on the wiring closet data, the quantity, placement, and/or configuration of the WLAN access points can be determined. Connections between the one or more distribution system switches and the WLAN access points can be determined. The wiring closet data can include redundant connection data to the WLAN access points. The quantity, placement, and/or configuration of the distribution system switches can be determined based at least on the floor plan data, the coverage data, and/or the capacity data. It can be ensured that UTP Cat5 cabling distances between access points and their respective distribution system switches in wiring closets do not exceed, for example, 100 meters, or 330 feet. The quantity, placement, and/or configuration of one or more distribution system switches connecting the WLAN access points at the WLAN site can be changed based at least on measured WLAN data. Dual homing of access points can be supported; the same or different distribution system switches can be used.

A group of distribution system switches that work together to support roaming users is a domain. In a domain, one distribution system switch can be defined as a seed device, which can distribute information to the distribution system switches defined in the domain. The domain can allow users to roam geographically from one distribution system switch to another without disruption of network connectivity. As users move from one location to another, their connections to servers can appear the same. When users connect to a distribution system switch in a domain, they connect as a member of a VLAN through their authorized identities. If the native VLAN for users is not present on the distribution system switch to which they connect, the distribution system switch creates a tunnel to that VLAN.

Computer code in various embodiments can be implemented in hardware, software, or a combination of hardware and software.

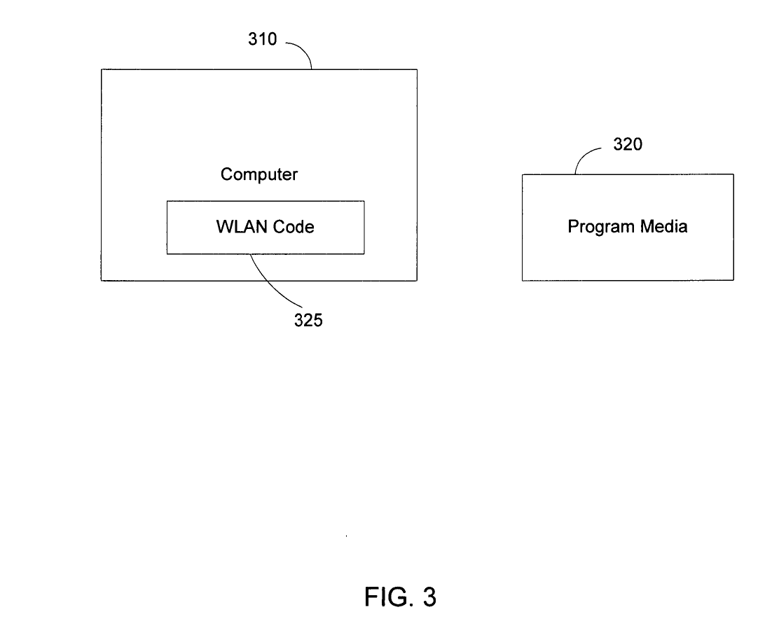

FIG. 3 illustrates a computer 310, which is programmed at least in part by code stored on program media 320. The program media 320 is used to place at least some of the code 325 on the computer 310.

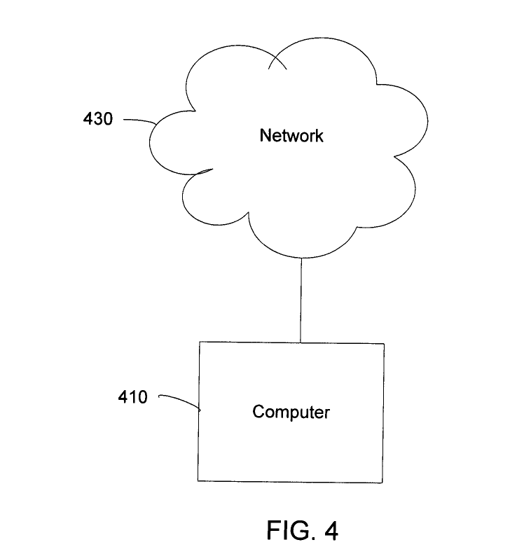

FIG. 4 illustrates a computer 410, which is programmed at least in part by code from a network 430. The network 430 is used to place code on the computer 410.

The computer running the code can be integral to or separate from networking elements such as distribution switches, access points, etc.

1. A method of planning a wireless local area network, comprising:
receiving floor plan data about a site for the wireless local area network;
receiving coverage data about the site for the wireless local area network;
receiving capacity data about the site for the wireless local area network; and
based at least on the floor plan data, the coverage data, and the capacity data, determining quantity, placement, and configuration of a plurality of access points of the wireless local area network.

2. The method of claim 1 wherein the floor plan data is imported.

3. The method of claim 1 wherein the floor plan data is manually drawn via computer.

4. The method of claim 1 wherein objects in the floor plan data are associated with radio frequency attenuation factors.

5. The method of claim 4 wherein objects in the floor plan data are associated with radio frequency attenuation factors that depend on a technology standard of the wireless local area network.

6. The method of claim 1 wherein the coverage data indicates coverage areas of the site serviced by the plurality of access points.

7. The method of claim 6 wherein the coverage data is indicated with at least the floor plan data.

8. The method of claim 6 wherein the coverage data depends on a technology standard of the wireless local area network.

9. The method of claim 8 wherein at least one coverage area supports one or more technology standards of the wireless local area network

10. The method of claim 1 further comprising:
receiving wiring closet data, the wiring closet data indicating one or more locations for one or more distribution system switches at the site for the wireless local area network, the one or more distribution system switches to the plurality of access points.

11. The method of claim 10 wherein determining quantity, placement, and configuration of the plurality of access points of the wireless local area network is further based at least on the wiring closet data.

12. The method of claim 11 wherein the wiring closet data includes redundant connection data to the plurality of access points.

13. The method of claim 1 further comprising:
based at least on the floor plan data, the coverage data, and the capacity data, determining at least one of quantity, placement, and configuration of one or more distribution system switches at the site for the wireless local area network, the one or more distribution system switches connecting to the plurality of access points.

14. The method of claim 13 further comprising:
determining connections between the one or more distribution system switches and the plurality of access points.

15. The method of claim 1 wherein the capacity data includes one or more throughput rates for stations serviced by the plurality of access points.

16. The method of claim 1 wherein the capacity data includes one or more average desired association rates for stations serviced by the plurality of access points.

17. The method of claim 1 wherein the capacity data includes one or more quantities of stations serviced by the plurality of access points.

18. The method of claim 17 wherein the capacity data includes one or more quantities of active stations serviced by the plurality of access points.

19. The method of claim 17 wherein the capacity data includes one or more quantities of total stations serviced by the plurality of access points.

20. The method of claim 1 further comprising:
receiving association data.

21. The method of claim 20 wherein determining quantity, placement, and configuration of the plurality of access points of the wireless local area network is further based at least on the association data.

22. The method of claim 20 wherein the association data includes allowable channels for the plurality of access points.

23. The method of claim 20 wherein the association data includes one or more minimum rates for beacons of the plurality of access points.

24. The method of claim 20 wherein the association data includes one or more minimum rates for probe responses of the plurality of access points.

25. The method of claim 1 wherein the configuration of the plurality of access points of the wireless local area network determined based at least on the floor plan data, the coverage data, and the capacity data, includes multi-homing for the plurality of access points.

26. The method of claim 1 wherein the configuration of the plurality of access points of the wireless local area network determined based at least on the floor plan data, the coverage data, and the capacity data, includes power levels for the plurality of access points.

27. The method of claim 1 wherein the configuration of the plurality of access points of the wireless local area network determined based at least on the floor plan data, the coverage data, and the capacity data, includes channel assignments for the plurality of access points.

28. The method of claim 1 wherein the placement of the plurality of access points of the wireless local area network determined based at least on the floor plan data, the coverage data, and the capacity data, is manually adjustable via computer.

29. The method of claim 28 further comprising:
based at least on manually adjusted placement of the wireless local area network, determining at least one of the quantity and the configuration of the plurality of access points.

30. The method of claim 28 further comprising:
based at least on manually adjusted placement of at least one access point of the wireless local area network, determining the placement of at least one other access point of the plurality of access points.

31. The method of claim 28 further comprising:
based at least on manually adjusted placement of at least one access point of the wireless local area network, determining at least one of the coverage data and the capacity data of the site for the wireless local area network.

32. The method of claim 1 further comprising:
displaying at least the quantity and the placement of the plurality of access points of the wireless local area network.

33. The method of claim 1 further comprising:
permitting manual adjustments via computer to one or more of: the quantity and the configuration of the plurality of access points of the wireless local area network.

34. The method of claim 33 further comprising:
based at least on the manual adjustments, determining at least one of the quantity, the placement, and the configuration of the plurality of access points.

35. The method of claim 33 further comprising:
based at least on manual adjustments, determining at least one of the coverage data and the capacity data of the site for the wireless local area network.

36. The method of claim 1 further comprising:
receiving preexisting access point data.

37. The method of claim 36 wherein determining quantity, placement, and configuration of the plurality of access points of the wireless local area network is further based at least on the preexisting access point data.

38. The method of claim 1 further comprising:
generating work order data based at least on the quantity, the placement, and the configuration of the plurality of access points of the wireless local area network.

39. The method of claim 38 wherein the work order data includes installation instructions for the plurality of access points of the wireless local area network.

40. The method of claim 39 wherein the work order data includes installation instructions for one or more distribution system switches connecting to the plurality of access points of the wireless local area network.

41. The method of claim 1 further comprising:
pushing distribution system switch configurations to one or more distribution system switches at the site for the wireless local area network, the one or more distribution system switches connecting to the plurality of access points.

42. The method of claim 41 wherein the distribution system switch configurations include management settings.

43. The method of claim 42 wherein the management settings include one or more of: HTTPS settings, telnet settings, SNMP settings, logging settings, and time zone settings.

44. The method of claim 41 wherein the distribution system switch configurations include IP service settings.

45. The method of claim 44 wherein the IP service settings include one or more of: static route settings, IP alias settings, DNS settings, and NTP settings.

46. The method of claim 41 wherein the distribution system switch configurations include authentication settings.

47. The method of claim 41 wherein the distribution system switch configurations include distribution system switch port settings.

48. The method of claim 37 wherein the distribution system switch port settings includes settings for distribution system switch ports connected to access points of the plurality of access points.

49. The method of claim 41 wherein the distribution system switch configurations include distribution system switch VLAN settings.

50. The method of claim 49 wherein the VLAN settings include one or more of: VLAN name settings, tunnel affinity settings, IP address settings, aging time settings, distribution system switch port VLAN settings, STP settings, IGMP settings, and static multicast port settings.

51. The method of claim 50 wherein the distribution system switch port VLAN settings specify membership of distribution system switch ports in VLANs.

52. The method of claim 1 further comprising:
pushing access point configurations to one or more access points of the plurality of access points.

53. The method of claim 52 wherein the access point configurations include SSID settings.

54. The method of claim 53 wherein the SSID settings include at least one of: beaconed SSID settings, encrypted data SSID settings, and unencrypted data SSID settings.

55. The method of claim 52 wherein the access point configurations include encryption settings.

56. The method of claim 55 wherein the encryption settings include at least one of: encryption standard settings and encryption key settings.

57. The method of claim 52 wherein the access point configurations include 802.11 settings.

58. The method of claim 53 wherein the 802.11 settings include at least one of: beacon interval settings, DTIM period settings, fragment threshold settings, long retry limit settings, maximum send lifetime settings, maximum receive lifetime settings, RTS/CTS settings, short retry limit settings, preamble settings, transmit power settings, channel number settings, and minimum transmit rate settings.

59. Code planning a wireless local area network, comprising:
code that performs receiving floor plan data about a site for the wireless local area network;
code that performs receiving coverage data about the site for the wireless local area network;
code that performs receiving capacity data about the site for the wireless local area network; and
code that performs, based at least on the floor plan data, the coverage data, and the capacity data, determining quantity, placement, and configuration of a plurality of access points of the wireless local area network.

60. An apparatus planning a wireless local area network, comprising:
means for receiving floor plan data about a site for the wireless local area network;
means for receiving coverage data about the site for the wireless local area network;
means for receiving capacity data about the site for the wireless local area network; and
means for, based at least on the floor plan data, the coverage data, and the capacity data, determining quantity, placement, and configuration of a plurality of access points of the wireless local area network.
